(19) United States
(12) Patent Application Publication
(10) Pub. No.: US 2022/0163128 A1
(43) Pub. Date: May 26, 2022

(54) BUTTERFLY VALVE SEAT AND VALVE SEAT CAVITY

(71) Applicant: Bray International, Inc., Houston, TX (US)

(72) Inventors: Partha CHINNASAMY, Houston, TX (US); Evan APOSTOLOU, Houston, TX (US); Austin COOPER, Houston, TX (US); Patrick O'CONNELL, Houston, TX (US)

(21) Appl. No.: 17/531,340

(22) Filed: Nov. 19, 2021

Related U.S. Application Data
(60) Provisional application No. 63/116,317, filed on Nov. 20, 2020.

(51) Int. Cl. F16K 27/02; F16K 1/36; F16K 1/22; F16K 1/46; F16K 1/226; F16J 15/34; F16J 15/48

(52) U.S. Cl. CPC F16K 27/0218; F16K 1/36; F16K 1/222; F16J 15/48; F16K 1/2261; F16J 15/3448; F16K 1/46

(57) ABSTRACT

The disclosure relates to a butterfly valve having a valve opening defined through the valve body and including a seat retainer fastened to the valve body; a disc with an optimized profile rotatably mounted within the valve opening; an interstice between the disc and valve body; a valve seat cavity defined in the seat retainer and the valve body; a fluid port defined in the valve body, wherein the fluid port is connected to the valve seat cavity and the interstice.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### BACKGROUND

Technical Field: The disclosure relates to the field of double offset butterfly valves, in particular the valve seats, valve seat cavities, discs and processes for manufacturing same.

The geometry of a butterfly valve is well known in the industry. In a butterfly valve, a disc rotates in a flow path to seal the flow path. In conventional butterfly valves, the valve disc moves through its full arc of ninety degrees of rotation, the diametrical axis of the disc will be parallel to the flow axis of the flow path when the valve is fully open, and the diametrical axis of the disc will be precisely perpendicular to the flow axis of the flow path, or flow way, when the valve is fully closed.

Improvements are needed in butterfly valve seats which operate in systems under extreme temperatures and pressures. The butterfly valve seats must operate correctly under a variety of conditions and maintain sealing capability through hundreds or thousands of cycles. Such valve seats must also inhibit failure and, relatedly, inhibit pieces of the valve seat from breaking-away. Thus there is a need for improved durability and performance of butterfly valve seats, particularly for extreme environments. There is also a need for more improved manufacturing processes for these valves and valve seats to improve performance while lowering costs and resources.

### BRIEF SUMMARY

The disclosure relates to a butterfly valve having a valve opening defined through the valve body and including a seat retainer fastened to the valve body; a disc with an optimized profile rotatably mounted within the valve opening; an interstice between the disc and valve body; a valve seat cavity defined in the seat retainer and the valve body; a fluid port defined in the valve body, wherein the fluid port is connected to the valve seat cavity and the interstice.

As used herein, “optimized disc profile” or “optimized profile” may be defined as delaying the contact of the seat with the disc via at least reducing sliding wear and minimizing/eliminating contact between the seat and disc when the valve is in the fully open (or 90 degree) position; “optimized disc profile” or “optimized profile” may also be defined to include the increased clearance between the disc and body to allow for more variation in production parts and allow adequate clearances when the valve experiences thermal contract at cryogenic temperatures; the “optimized disc profile” or “optimized profile” may be defined to include the minimized spherical disc sealing surface. “Optimized disc profile” features a sealing zone with maximum interference between seat and disc, to provide adequate leakage performance when the valve is at fully closed position, and at the same time designed to have minimal interference between seat and disc throughout the valve operation from fully open position to fully closed position or vice versa.

### BRIEF DESCRIPTION OF THE DRAWINGS

The exemplary embodiments may be better understood, and numerous objects, features, and advantages made apparent to those skilled in the art by referencing the accompanying drawings. These drawings are used to illustrate only exemplary embodiments and are not to be considered limiting of its scope, for the disclosure may admit to other equally effective exemplary embodiments. The figures are not necessarily to scale and certain features and certain views of the figures may be shown exaggerated in scale or in schematic in the interest of clarity and conciseness.

FIG. 1 depicts an exploded isometric view of an exemplary embodiment of the improved butterfly valve and valve seat assembly.

FIG. 2A depicts a front view of the exemplary embodiment of an improved butterfly valve and valve seat assembly in a fully closed position.

FIG. 2B depicts a cross-section view along line 2B-2B in FIG. 2A of the exemplary embodiment of the improved butterfly valve and valve seat assembly in the fully closed position.

FIG. 2C depicts an enlarged cross-section view as defined by circle 2C in FIG. 2B of the exemplary embodiment of the improved butterfly valve and valve seat assembly in the fully closed position.

FIG. 2D depicts an enlarged cross-section view as defined by circle 2D in FIG. 2C of the exemplary embodiment of the improved butterfly valve and valve seat assembly in the fully closed position.

FIG. 3A depicts a front view of the exemplary embodiment of an improved butterfly valve and valve seat assembly in an open position.

FIG. 3B depicts a cross-section view along line 3B-3B in FIG. 3A of the exemplary embodiment of the improved butterfly valve and valve seat assembly in an open position.

FIG. 3C depicts an enlarged cross-section view as defined by circle 3C in FIG. 3B of the exemplary embodiment of the improved butterfly valve and valve seat assembly in an open position.

FIG. 3D depicts an enlarged cross-section view as defined by circle 3D in FIG. 3C of the exemplary embodiment of the improved butterfly valve and valve seat assembly in an open position.

FIG. 4 depicts a front view of an exemplary embodiment of an improved valve body.

FIG. 5 depicts an enlarged cross-section view of an exemplary embodiment of the improved butterfly valve assembly and valve seat showing the flow of fluid and pressure.

FIG. 6 depicts an enlarged cross-section view of an exemplary embodiment of the improved butterfly valve assembly and valve seat showing an exemplary embodiment of the seat angle.

FIG. 7 depicts an enlarged cross-section view of an alternative exemplary embodiment of the improved butterfly valve assembly and valve seat showing the flow of fluid and pressure.

FIG. 8 depicts an enlarged view of an exemplary embodiment of an improved valve seat.

FIG. 9A depicts a front view of an alternative exemplary embodiment of an improved butterfly valve and valve seat assembly in a fully closed position.

FIG. 9B depicts a cross-section view along line 9B-9B in FIG. 9A of the alternative exemplary embodiment of the improved butterfly valve and valve seat assembly in the fully closed position.

FIG. 9C depicts an enlarged cross-section view as defined by circle 9C in FIG. 9B of the alternative exemplary embodiment of the improved butterfly valve and valve seat assembly in the fully closed position.

FIG. 9D depicts an enlarged cross-section view as defined by circle 9D in FIG. 9C of the alternative exemplary embodiment of the improved butterfly valve and valve seat assembly in the fully closed position.

### DESCRIPTION OF EMBODIMENT(S)

The description that follows includes exemplary apparatus, methods, techniques, and instruction sequences that embody techniques of the inventive subject matter. However, it is understood that the described embodiments may be practiced without these specific details.

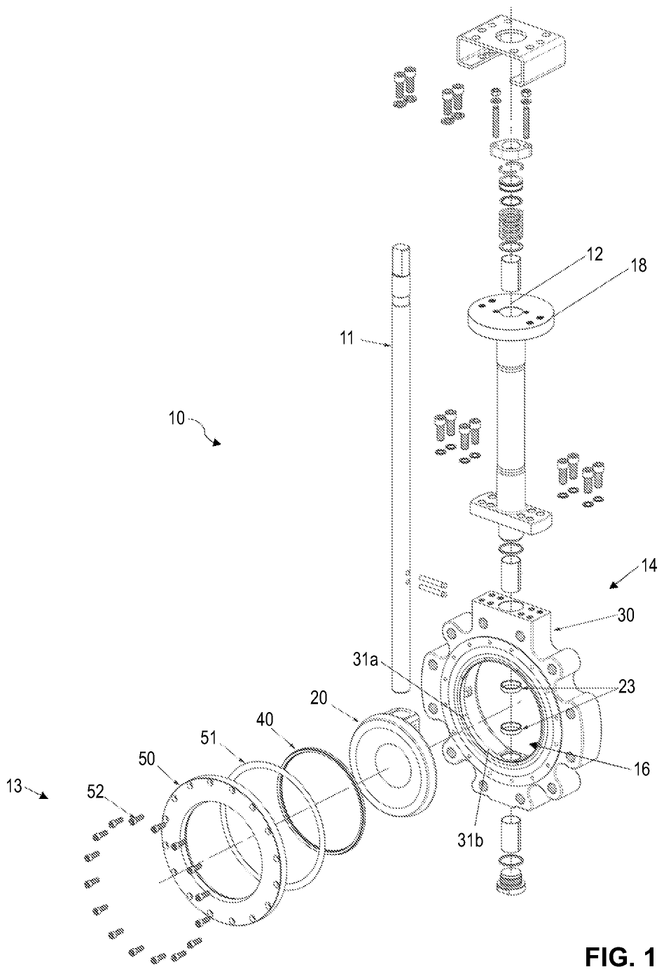

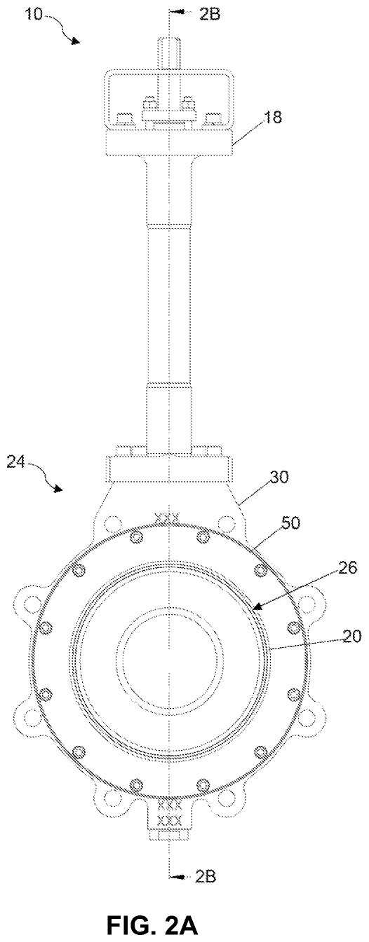

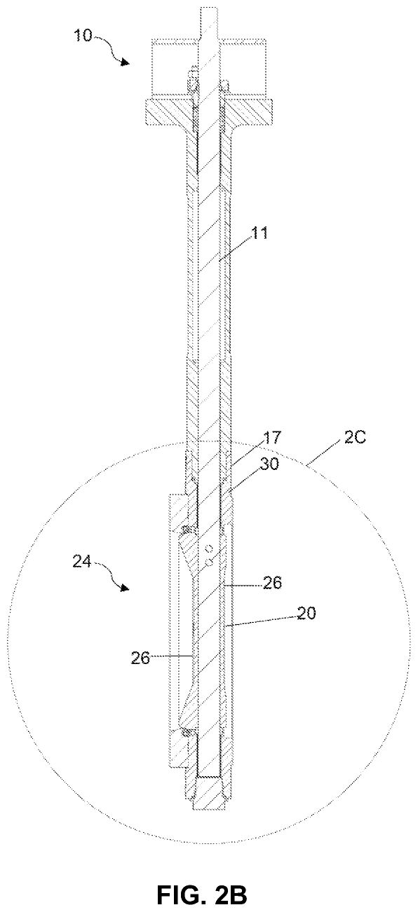

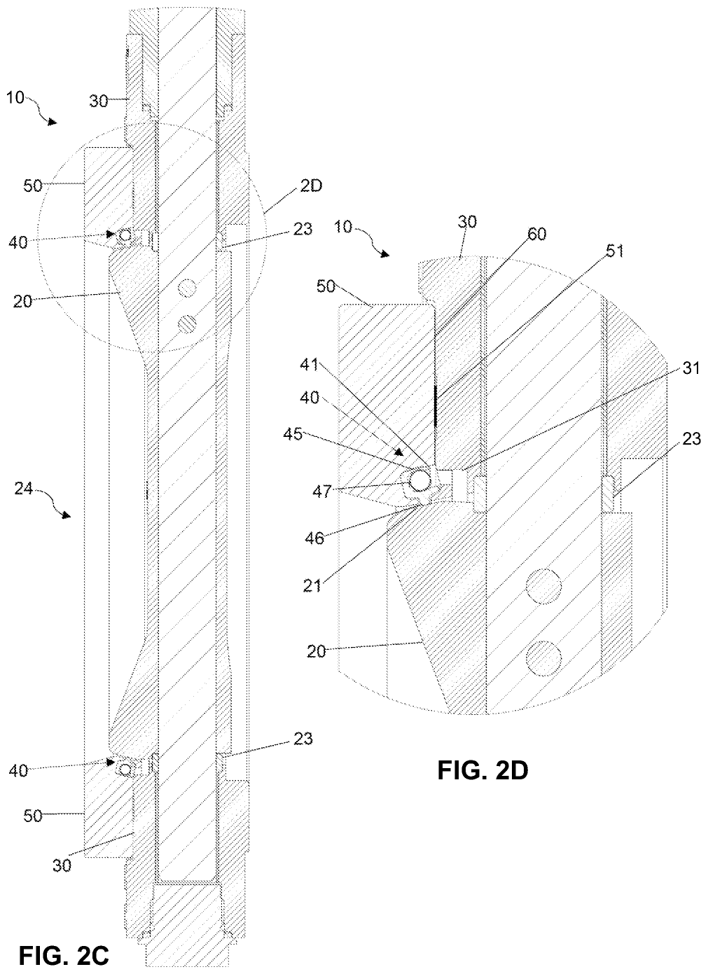

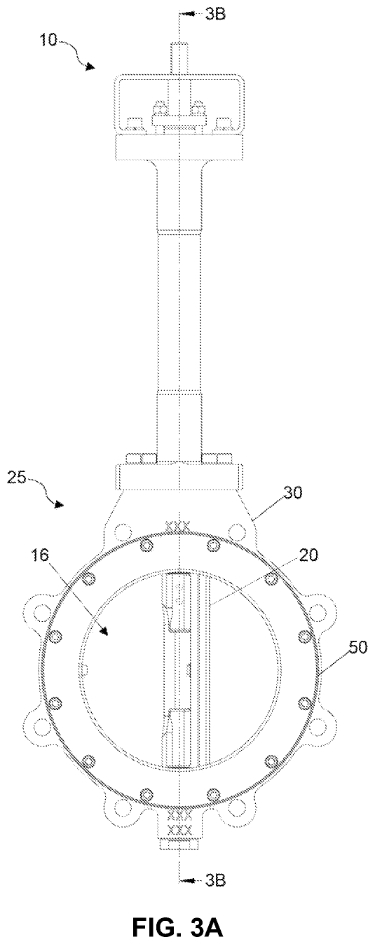

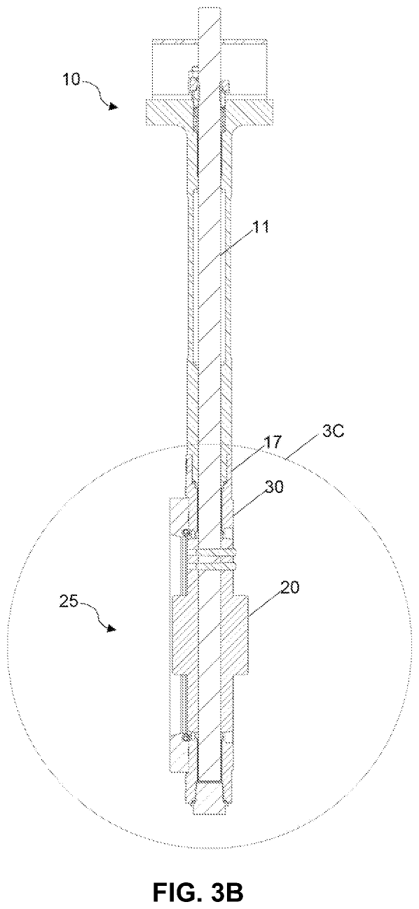

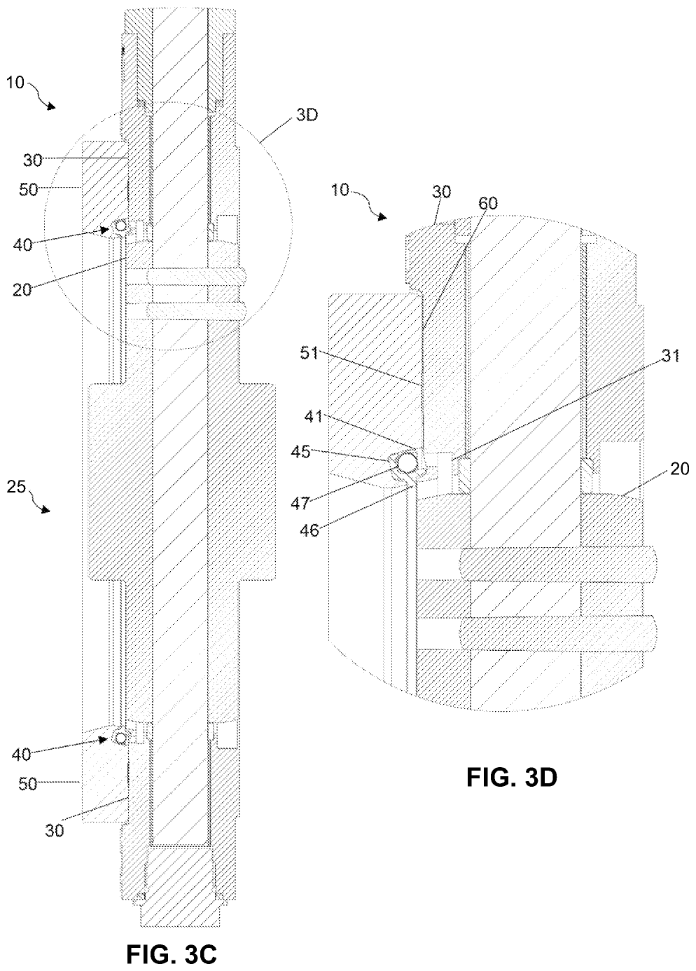

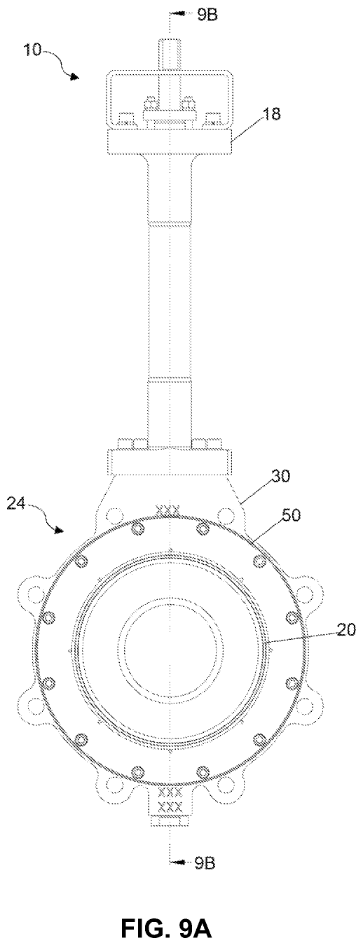

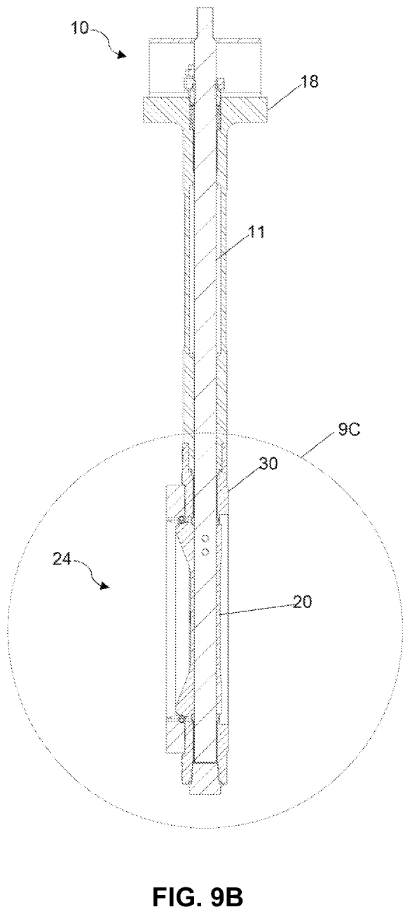

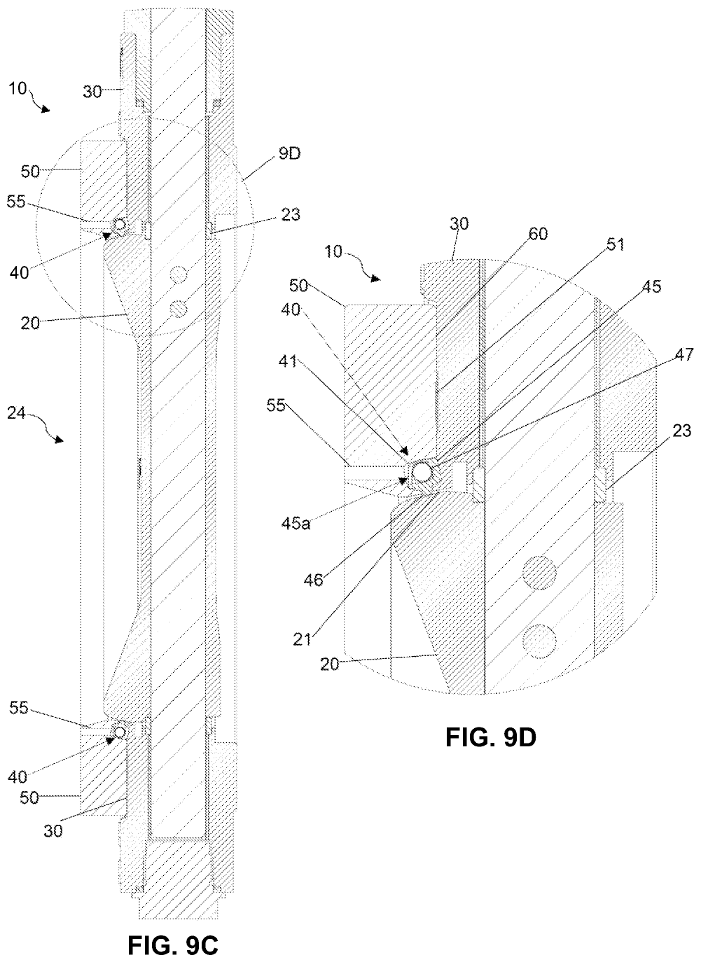

FIG. 1 depicts an exploded isometric view of an exemplary embodiment of the improved butterfly valve or valve assembly 10. The improved butterfly valve or valve assembly 10 is a double offset cryogenic type butterfly valve, which includes at least a control element, valve disk or disc 20, a valve body 30, a valve stem 11, a valve seat 40, and a seat retainer 50. The exemplary embodiments of the butterfly valve 10 may be optimized for extremely low and extremely high temperature performance. By way of example only, and not to be limited to, the improved valve 10 may operate between the temperature ranges of −320° F. to 500° F. (or −196° C. to 260° C.). Further, the current disclosure includes valves 10 of sizes ranging from 2½ inches to 60 inches or larger. The valve assembly 10 may further define a front side 13 and a back or rear side 14, and a rotational axis 12. The valve body 30 defines a valve opening 16 in which the valve disc 20 may rotate about the rotational axis 12. The valve stem (or alternatively, valve stem pieces) 11 is connected through the bonnet 18 including through the valve neck 17 (shown in FIGS. 2B, 3B), and through the valve body 30 to the valve disc 20. The valve stem 11 rotates about the rotational axis 12 of the improved valve 10. The valve disc 20 is mounted or connected to the stem 11 such that the rotational movement of the valve stem 11 will also rotate the valve disc 20 between a closed position 24 (exemplary embodiment shown in FIGS. 2A-2D) and at least one open position (exemplary embodiment shown in FIGS. 3A-3D) within the valve opening 16. When the disc 20 is not obstructing or occluding the opening 16, the valve 10 is in an open position 25, and fluid or media 15 can move freely through the opening 16. When the disc 20 is fully obstructing the opening 16, the valve 10 is in a closed position 24 and no media or fluid 15 can move through the opening 16. In the exemplary embodiments as depicted, the flow of media or fluid 15 may flow from the rear side 14 towards the front side 13 when the valve 10 is in an open position 25; however, it is to be appreciated that in alternative exemplary embodiments, the flow of fluid or media 15 may be reversed (i.e. the fluid 15 may flow from the front 13 towards the rear 14) when the valve 10 is in an open position 25. In further alternative exemplary embodiments depicted in FIGS. 9A-9D, when valve 10 configuration is such that fluid flow 15 is reversed and seat retainer 50 is upstream, the fluid ports 55 may instead be located on seat retainer 50 and seat 40 may be flipped along the vertical axis 12 so that jacket opening 45a of the seat 40 faces the fluid ports 55.

The valve disc, disk, or control element 20 may include two substantially circular surfaces or disc faces 26 and a rim or outer diameter/surface 21 that connects or joins the two substantially circular surfaces/faces 26. The rim of the valve disc 21 may optionally define a partial convex, domed, or spherical diameter, curve, surface, or optimized profile. The spherical diameter rim 21 of the disk is fully sealed and engaged against the lip or extension 46 of the valve seat 40 when the valve 10 is in a closed position such that no fluid or other media flow may pass between the disc 20 and the valve seat 40. The disc 20 or outer or sealing surface 21 of the disc 20 may also have a disc surface finish 22 of, by way of example only, and not to be limited to, 8 RMS or 12 RMS, or any surface finish of less than 64 RMS (wherein “RMS” may be defined as the Root Mean Square of a surfaces measured microscopic peaks and valleys). Other RMS finishes are considered within the scope of the disclosure. The disc profile 21 is optimized to delay contact of the seat 40 with the disc 20 reducing sliding wear and eliminating contact between the seat 40 and disc 20 when the valve 10 is in the fully open (or 90 degree) position 25. The optimized profile 21 also increases the clearance between the disc 20 and body 30 to allow for more variation in production parts and allow adequate clearances when the valve 10 experiences thermal contraction and/or expansion at cryogenic temperatures, and/or as the temperature varies within a known or anticipated operating range. Accounting for the thermal contraction and/or expansion is critical to the optimized disc profile 21 to ensure sufficient clearance is available, especially during qualification testing of valves 10. A butterfly valve 10 without this optimized profile 21 as relates to thermal contraction and/or expansion may fail qualification testing. The disc profile 21 is also optimized by minimizing the spherical disc 20 sealing surface. The “Optimized disc profile” features a sealing zone 70 with maximum interference between seat 40 and disc 20, to provide adequate leakage performance when the valve is at fully closed position 24 or vice versa, and at the same time designed to have minimal interference between seat 40 and disc 20 throughout the valve operation from fully open position 25 to fully closed position 24 or vice versa.

A spacer 23 may be located on each of the top and bottom of the disc 20 (see e.g. FIGS. 1 and 2D). The spacers 23 may have a ring-like or annular shape and are installed around the stem 11, between the disc 20 and the valve body 30. The spacers 23 may be made of a nitrogen-strengthened stainless steel alloy material. The spacers 23 may align the disc 20 with high precision within the flow bore 16 of the valve body 30. The material of the spacers 23 is selected to reduce metal particle generation or material galling, build-up, or accumulation due to repeated cycles of opening and closing the valve 10. Alternative exemplary embodiments include using other materials. Alternative embodiments also cover valve designs without spacers and other means of establishing disc concentricity relative to the body.

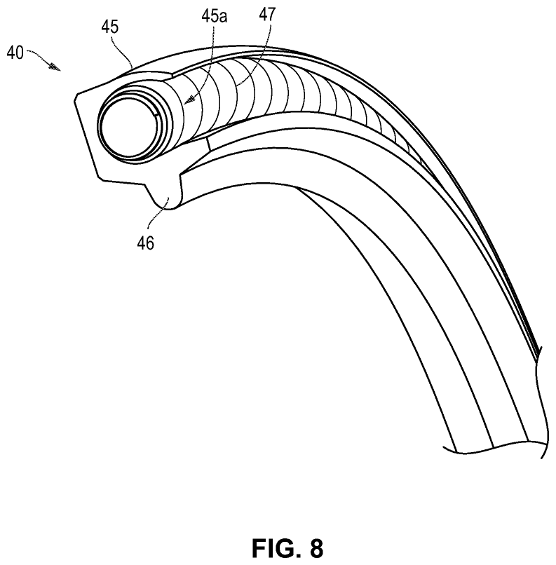

Referring at least to FIGS. 1 and 8, the valve seat 40 includes a jacket or lip seal jacket 45 with a spring or double helical spring energizer 47 inserted into said jacket 45. The jacket 45 may only partially encapsulate or surround the spring 47, having a jacket opening 45a wherein the spring 47 may be partially exposed. In further alternative exemplary embodiments, the jacket 45 may fully encapsulate or surround the spring 47. The valve seat 40, when assembled, is located or situated between the valve body 30 and the seat retainer 50, adjacent to, surrounding and/or encircling the valve opening 16. The valve seat jacket 45 may, in certain exemplary embodiments, be made of a polytetrafluoroethylene (PTFE) material. The jacket 45 may alternatively be composed of any other compatible polymer material as known to one of ordinary skill in the art. The jacket 45 may have a substantially circular or ring-like shape. The spring 47 may, in certain exemplary embodiments, be made of a non-magnetic cobalt-chromium-nickel-molybdenum alloy material. The spring 47 may alternatively be composed of any other high strength, corrosion resistant and high fatigue strength material as known to one of ordinary skill in the art. The spring 47 exerts a spring force 48 against the interior of the jacket 45 at any pressure environment of the system (including no pressure, low and high pressures). The jacket 45 includes a lip, extension, or jacket extension 46 which protrudes or extends from the jacket 45. The lip or extension 46 may contact or seal against the perimeter or outer surface 21 of the disc 20 when the valve 10 is in the closed position 24. The lip or extension 46 does not contact or seal against the perimeter or outer surface 21 of the disc 20 when the valve 10 is in an open position 25; instead the extension 46 extends or protrudes valve opening 16 through the cavity opening 42 in the open position 25 of the valve 10. In the closed position 24, the lip 46 of the seat 40 provides a minimal contact area to the outer surface 21 of the disc 20 during opening and closing operation, thus greatly reducing torque and wear and tear between the seat 40 and disc 20 compared to conventionally known embodiments for existing butterfly valve assemblies. The seat 40 may also be oxygen compatible and configured for oxygen-cleaning.

As best depicted in FIGS. 2D, 3D and 5-7, the valve seat 40 is positioned at a seat angle 44 within a seat cavity or pocket 41. The seat cavity 41 may be a chamber or opening defined at an interface or surface 60 between the seat retainer 50 and the valve body 30. The seat cavity 41 may have a first series of grooves, curves, or profiles 61 defined along the interface on the valve body 30 side and a second series of grooves, curves, or profile 62 defined on the valve seat retainer 50 side. The full (or almost full) containment of the seat 40 within the machined grooves 61, 62 (or machined cavity 41) of the seat retainer 50 and the body 30, minimizes the impact on sealing performance due to any thermal contraction and expansion of the valve seat 40. The cavity 41 may also define an opening or outlet 42 wherein the lip or extension 46 of the jacket 45 may protrude or extend out of the cavity 41.

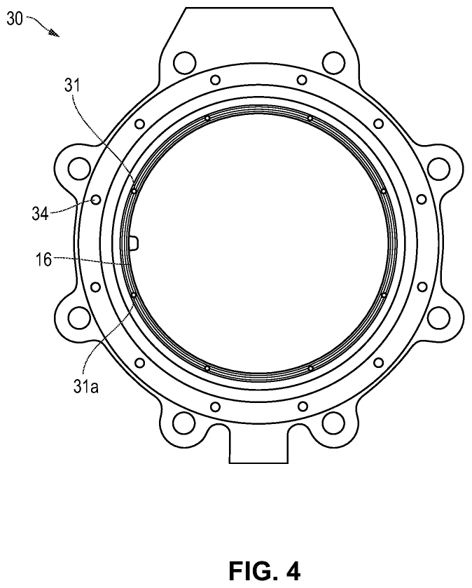

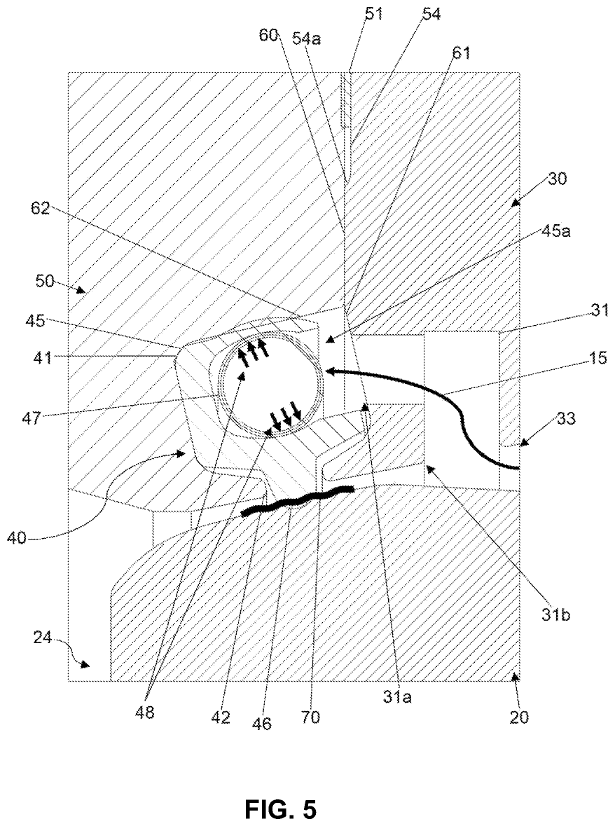

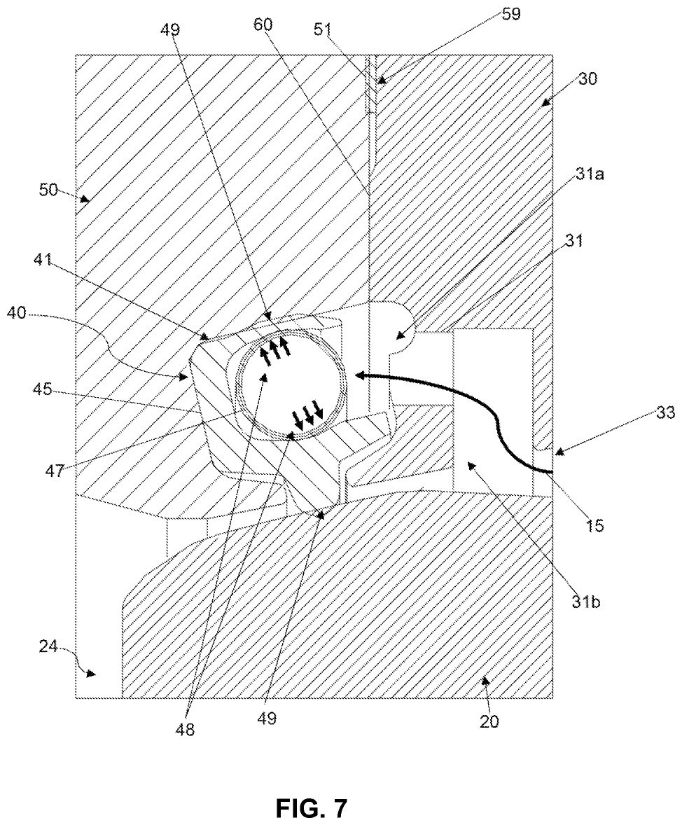

Further, the seat cavity 41 is connected or opens to a fluid port or upstream hydraulic connection 31. In certain exemplary embodiments, the fluid ports 31 include multiple ⅛ inch holes/openings drilled through the valve body 30 and arranged around or adjacent to the perimeter or circumference of the valve opening 16, for example fluid ports 31 spaced equidistantly around the opening 16, (see e.g., at least FIGS. 1 and 4). The fluid port 31 opens into the valve body 30 side (or the grooves or profile 61) of the seat cavity 41 at a first end of the fluid port 31a (see e.g. FIGS. 4-7). The first end 31a may be substantially directed, targeted, open or facing towards the jacket opening 45a of the valve seat 40. The fluid port 31 of the valve body 30 opens at a second end 31b into a disc annulus or annular interstice 33, wherein the disc annulus or annular interstice 33 is defined as a space or region between the valve disc 20 and the valve body 30. The flow channels defined by the first end 31a and second end 31b of each respective fluid port 31 generally intersects at a right angle seen schematically in fluid pressure flow line 15 as depicted in FIG. 7. Fluid 15 is able to flow or travel through the disc annulus 33 and the fluid port 31 when the valve 10 is in a closed position 24. Fluid 15 may first enter second end 31b, next exit first end 31a, and then enter the jacket opening 45a to boost or combine with the spring force 48. The cavity 41 and fluid port 31 may have different profiles 61, 62, geometries or shapes (see by way of example only, and not to be limited to, FIGS. 5-7) defined in the valve body 30 and seat retainer 50, in a variety of exemplary and alternative exemplary embodiments. In alternative exemplary embodiments as illustrated in FIGS. 9A-9D, a fluid port 55 may instead be defined or drilled in the seat retainer 50 as a downstream hydraulic connection.

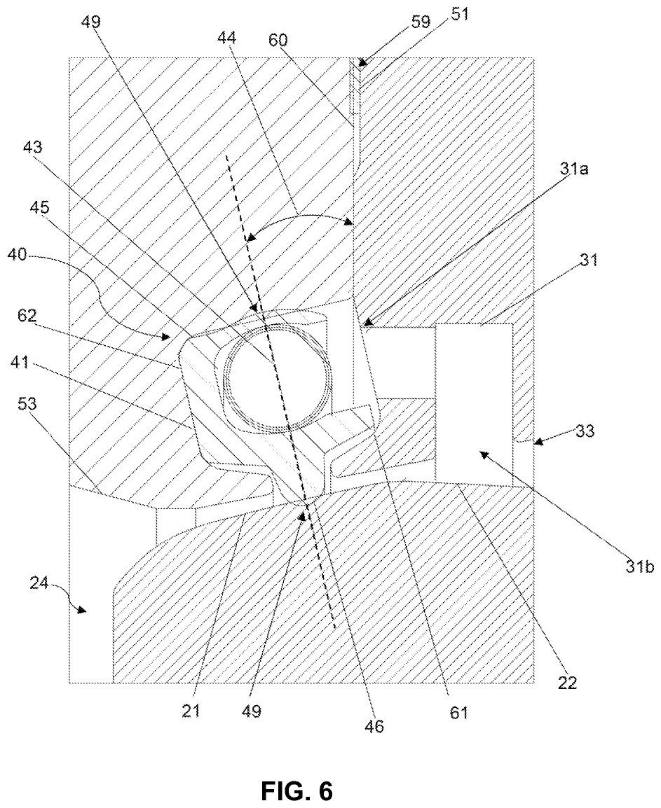

FIG. 6 depicts an enlarged cross-section view of an exemplary embodiment of the improved butterfly valve assembly 10 and valve seat 40 showing an exemplary embodiment of the seat angle 44. The seat angle 44 is defined as the angle between seat axis 43 and the interface 60 between the seat retainer 50 and the valve body 30. The seat axis 43 is defined as the perpendicular or normal axis at the engagement, contact or sealing point between the seat 40 and the rim/surface 21 of disc 20 (i.e. as the rim/surface 21 of disc 20 may be curved an interstitial point/segment of contact 21a proximate primary seal 49 may be defined, with seat axis 43 being along a line or surface perpendicular thereto). Further, wherein the valve seat 40 is at the top or bottom of the valve 10, the rotational axis 12 and the interface 60 between the seat retainer 50 and valve body 30 may be parallel axes. By way of example, the seat angle 44 is critical to seal performance of the seat 40 because the rim/surface 21 of the disc must align with the primary seal 49 of seat 40, and may be preferably between the range of 10° and 45°. The seat angle 44 is selected to delay contact of the seat 40 with the disc 20, therefore reducing sliding wear. The angle 44 and orientation of the seat 40 is selected such that the central axis 43 of the seat 40 cross-section intersects with the center point of the disc 20 sphere (wherein the disc 20 sphere is defined by the spherical surface/rim 21). This reduces compressive loading on the seat 40 which are not in line with the primary seals 49 (side loading). Delayed contact of primary seal 49 with disc surface 21 is desired to create no contact between the seat extension 46 and the disc surface 21 while the valve 10 is in an open position 25, thus reducing wear and increasing life of the valve 10.

The seat retainer 50 may have a substantially ring-like or annular shape which is mounted over, covers, and secures a seat retainer gasket 51 and the valve seat 40 to the valve body 30. The seat retainer gasket 51 is installed or seated between the seat retainer 50 and the valve body 30, circumferentially around or encircling the seat 40 (see e.g., at least FIGS. 1, 2D and 3D). A plurality of fasteners 52 may secure the seat retainer gasket 51 and valve seat 40 between the seat retainer 50 and the valve body 30. The valve body 30 may define fastener openings 34 to receive the fasteners 52. The fasteners 52, may in certain exemplary embodiments, be socket head cap screws 52 (other types of fasteners as known in the art are considered within the scope of this disclosure). The seat retainer 50 may also have a seat retainer surface finish 53 of, by way of example only, and not to be limited to, 8 RMS or 12 RMS, or any surface finish of less than 64 RMS (wherein “RMS” may be defined as the Root Mean Square of a surfaces measured microscopic peaks and valleys). The disc surface finish 22 and the seat retainer surface finish 53 may be produced by single pass machining or multiple pass machining. Furthermore, the valve body 30 and the seat retainer 50 may also be made, manufactured, or produced using single pass machining, in particular the grooves 61, 62 which define the seat cavity 41. The gasket sealing chamber width or gasket groove width 54a is selected such that there is enough allowance on the gasket sealing chamber 54 to contain gasket 51 particles after compression.

As depicted in FIGS. 2A-2D and 5-7, when the valve 10 is in the closed position 24, the valve seat 40 is energized via fluid and pressure 15 from the rear side 14 of the valve 10. The seat 40 may be energized at relatively or comparatively low pressure (even no pressure). Generally, the spring 47 energizes the seat 40 at low pressures. To boost or supplement the spring 47 fluid pressure (i.e. via in-line fluid flow media hydraulically channeled in the direction and/or depicted by the respective fluid flow paths 15) energizes the seat 40 when the valve 10 is in the closed position 24 (i.e. at a time when it is critical to energize the seat 40 and primary seal 49). Therefore, media, fluid, or pressure 15 at higher or increased pressure provides additional or further assistance to reinforce or strengthen the sealing capabilities of the seat 40. The fluid or pressure 15 travel or flow through the disc annulus/interstice 33 and fluid port 31 to engage the spring 47 within the jacket 45. The spring 47, as a result of the fluid 15 and as assisted with the pressure/fluid 15, exerts an increased spring force 48 against the interior of the jacket 45, such that the jacket 45 engages (e.g. by sealing) or seals against the cavity 41 and the valve disc 20. The jacket 45 of the seat 40 when pressurized with fluid or media 15 may expand within the seat cavity 41 and against the seat retainer 50, the valve body 30 and the disc 20. Hence, the seat retainer 50 is also further assisted. Exemplary embodiments of the primary sealing points or contact points 49 when the valve 10 is in the closed position 24 are depicted in at least FIGS. 6-7. By way of example only, the lip or extension 46, as a result of the assistance of fluid/pressure 15 and the spring force 48, engages and seals against the outer surface 21 of the disc 20 at a first sealing point or primary sealing point 49; and another sealing point or primary sealing point 49 exists wherein the jacket 45 engages and seals against the top of the cavity 41 as a result of the assistance from pressure/fluid 15 and spring force 48. A third sealing point or primary sealing point 59 exists where the seat retainer gasket 51 engages and seals the area or region between the valve body 30 and the seat retainer 50, wherein the third sealing point 59 does not rely on fluid pressure 15 in maintaining the sealing position. The fluid pressure 15 provides the primary sealing points 49 with assistance in maintaining the position and longevity of the seals 49 and strengthening/reinforcing the seals 49. The primary seals 49, 59 seal at different locations to prevent leakage when the valve 10 is in a closed position 24. The improved seat 40 of the valve 10 enables unidirectional tight shut-off of the valve 10.

FIGS. 3A-3D depict various views of an exemplary embodiment of the improved valve or valve assembly 10 in an open position 25. When the valve 10 is in an open position, the disc 20 does not obstruct the flow of fluid 15 through the valve opening 16. Moreover, the lip or extension 46 of the valve seat 40 does not engage the outer surface 21 of the disc 20 in the open valve position 25.

FIGS. 9A-9D depict various views of an alternative exemplary embodiment of an improved butterfly valve and valve seat assembly 10 in a fully closed position 24, wherein the fluid port 55 is defined through the seat retainer 50.

While the embodiments are described with reference to various implementations and exploitations, it will be understood that these embodiments are illustrative and that the scope of the inventive subject matter is not limited to them. Many variations, modifications, additions, and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A butterfly valve having a valve opening defined through the valve body comprising:
a seat retainer fastened to the valve body;
a disc with an optimized profile rotatably mounted within the valve opening;
an interstice between the disc and valve body;
a valve seat cavity defined in the seat retainer and the valve body; and
a fluid port defined in the valve body, wherein the fluid port is connected to the valve seat cavity and the interstice.

2. The butterfly valve of claim 1, further comprising a valve seat positioned at a seat angle within the valve seat cavity, wherein the seat angle is defined as the angle between an axis normal to an engagement point between the valve seat and the disc in a closed position of the butterfly valve and an interface between the seat retainer and the valve body.

3. The butterfly valve of claim 2, wherein the seat angle is between a range of 10° to 45°.

4. The butterfly valve of claim 3, wherein the seat retainer and the disc each have a surface finish of less than 64 RMS.

5. The butterfly valve of claim 4, further comprising an outer surface of the disc, wherein the outer surface of the disc comprises a partial spherical surface, which has minimal contact with the valve seat during opening and closing operation.

6. The butterfly valve of claim 5, wherein when the butterfly valve is in the closed position, further comprises a first seal between the valve seat and the disc; a second seal between the valve seat and the valve seat cavity; and a third seal between a seat retainer gasket and the valve body.

7. The butterfly valve of claim 6, wherein the valve seat is comprised of a spring partially enclosed by a jacket, and wherein the jacket defines an extension extending out of the valve seat cavity.

8. The butterfly valve of claim 7, wherein when the butterfly valve is in the closed position, the valve seat and disc are only in contact at the extension of the jacket.

9. The butterfly valve of claim 8, further comprising a first spacer is installed at a top of the disc and a second spacer installed at a bottom of the disc, and wherein both spacers surround a stem of the butterfly valve and are composed of nitrogen-strengthened stainless steel alloy material.

10. The butterfly valve of claim 1, wherein the butterfly valve comprises a cryogenic butterfly valve configured for undergoing thermal expansion and/or contraction within an anticipated operating temperature range.

11. A butterfly valve body defining a valve opening and comprising
one or more grooves defined on a front of the butterfly valve body, wherein the one or more grooves are configured to receive a valve seat; and
one or more fluid ports defined through the valve body, wherein each fluid port is connected at a first end to the one or more grooves; and wherein each fluid port is connected at a second end to the valve opening.

12. A method of energizing a valve seat installed within a butterfly valve, wherein the butterfly valve has a disc rotatable within a valve opening, comprising the steps of:
rotating the disc of the butterfly valve into a closed position, wherein the disc obstructs the valve opening;
engaging an extension of the valve seat against an outer surface of the disc;
providing a flow of fluid through a fluid port defined in the butterfly valve to the valve seat; and
pressurizing the valve seat through the flow of fluid and reinforcing the sealing of the contact area between the disc and the valve seat.

13. The method according to claim 12, wherein the valve seat is contained in a valve seat cavity defined in a valve body and a seat retainer.

14. The method according to claim 13, wherein the valve seat cavity is connected to the fluid port.

15. The method according to claim 14, further comprising the step of expanding the valve seat within the valve seat cavity as a result of the flow of fluid to the valve seat.

16. The method according to claim 15, further comprising a seat retainer gasket installed between the seat retainer and the valve body; and further comprising the steps of providing a first seal between the extension of the valve seat and the disc; providing a second seal between the valve seat and the valve seat cavity; and providing a third seal between the seat retainer gasket and the valve body.

17. The method according to claim 16, wherein the valve seat is positioned at a seat angle within the valve seat cavity, wherein the seat angle is within the range of 10° to 45°.

18. The method according to claim 17, further comprising the steps of providing an optimized disc profile of the disc;
delaying contact of the valve seat with the disc;
reducing sliding wear;
eliminating contact between the valve seat and the disc when the butterfly valve is in a fully open position;
providing increased clearance between the disc and a body of the valve.

19. The method according to claim 18, wherein the optimized disc profile is provided by minimizing a sealing surface of the disc.

20. The method according to claim 19, further comprising the steps of providing a sealing zone having maximum interference between the valve seat and the disc in a closed position; and providing minimum interference of the sealing zone between the valve seat and the disc during the step of rotating the disc.

21. The method according to claim 20, further comprising the step of preventing material galling via at least one spacer installed at the disc and around a stem of the butterfly valve.

22. The method according to claim 21, further comprising the steps of rotating the disc into an open position; allowing the flow of fluid through the valve opening; and removing sealing between the extension of the valve seat and the disc.

23. The method according to claim 12, further comprising the step of providing an optimized disc profile of the disc; and
wherein the butterfly valve is contracting and/or expanding thermally as temperature varies within an anticipated operating temperature range.

24. A method of manufacturing a butterfly valve comprising the step of machining a seat retainer of the butterfly valve and a valve body of the butterfly valve in a single pass.

25. The method of claim 24, further comprising the step of machining a surface finish of the disc and a surface finish of the seat retainer in the single pass, wherein the surface finish of the disc and the surface finish of the seat retainer is less than 64 RMS.

26. The method of claim 25, further comprising the step of machining the disc to provide increased clearance between the disc and the valve body.

27. The method of claim 26, further comprising the step of machining a spherical sealing surface of the disc, and wherein the sealing surface of the disc is minimized.
